(19) United States
(12) Patent Application Publication
(10) Pub. No.: US 2001/0048504 A1
(43) Pub. Date: Dec. 6, 2001

(54) Nose pad of eyeglass frame

(76) Inventor: Hae-Ok Joo, Seoul (KR)

Correspondence Address: Burton A. Amernick, Connolly Bove Lodge & Hutz LLP, P.O. Box 19088, Washington, DC, 20036-0088, US

(21) Appl. No.: 09/767,825

(22) Filed: Jan. 24, 2001

(30) Foreign Application Priority Data
Jun. 2, 2000 (KR) 2000-15791

(51) Int. Cl. G02C 5/12

(52) U.S. Cl. 351/136; 351/139

(57) ABSTRACT

An eyeglass frame in which the nose pad is extended from an internal center of a nose bridge connecting both lens rims so that the nose pad may support at an upper surface of the wearer's nose. As in the first example there is a pin like support member protruding from the inner side of the nose bridge allowing for an arc shaped pad to be fixed onto it via a hole located on the pad. In the second example two such protruding support members are joined at the tip via an arc joint and covering this arc joint is a soft multi-sided tube. In the third example a flat plate support member allows for an arc shaped pad to be fixed onto it. This support member and nose bridge is covered over by the arc shaped pad. In the fourth example a block support member located half way up the glass frame has at one end an arc cut out of it and at that same end there are two holes for two pins to be located in allowing for the arc shaped pad to be fixed onto the support member.

### TECHNICAL FIELD

The present invention relates to a nose pad of eyeglass frame, and more particularly, to an eyeglass frame in which a nose pad is extended from an internal center of a nose bridge connecting both lens rims so that the nose pad may support at an upper surface of the wearer's nose whereas in a conventional frame a nose pad is extended from each lens rim.

### BACKGROUND OF THE INVENTION

In general, a nose pad of eyeglass frame is extended from each lens surround rim and is adapted to bear on the nose of a wearer of the eyeglass frame. However, such a conventional eyeglass frame is subject to the following drawbacks:

1. Such a conventional configuration of the pads does not fit various shapes and height of noses of people, and accordingly the eyeglass frames slip down from a wearer's nose or they are uncomfortable to wear. Moreover, the wearer of the eyeglass(spectacle) may suffer the weight of the eyeglass(spectacle) concentrated onto both point of the wearer's nose due to a conventional nose pad configuration.

2. Since both nose pads are required to be attached to the rails of both glass pieces in exactly the same point and shape, the operation is labor intensive and the production cost is high. In addition, a necessity of balancing between both nose pads causes the failure rate to increase.

### SUMMARY OF THE INVENTION

It is an object of the present invention to provide an eyeglass frame in which a pad member is extended from an internal center of a nose bridge connecting both glass pieces and the number of components is reduced, thereby obtaining a simple and light-weight eyeglass frame, resulting in a reduction in manufacturing costs.

To accomplish the above object of the present invention, there is provided an eyeglass frame in which a pad member is extended from an internal center of a nose bridge connecting both glass pieces, said pad member has at an end thereof an arc-shaped support member for supporting the eyeglass frame at an upper surface of the wearer's nose.

### BRIEF DESCRIPTION OF THE DRAWINGS

FIG. 1 is a separated perspective view of an eyeglass frame according to first example of the present invention;

FIG. 2 is an enlarged sectional view illustrating a combined eyeglass frame according to first example of the present invention;

FIG. 3 is a separated perspective view of an eyeglass frame according to second example of the present invention;

FIG. 4 is an enlarged sectional view illustrating a combined eyeglass frame according to second example of the present invention;

FIG. 5 is a separated perspective view of an eyeglass frame according to third example of the present invention;

FIG. 6 is an enlarged sectional view illustrating a combined eyeglass frame according to third example of the present invention;

FIG. 7 is a separated perspective view of an eyeglass frame according to fourth example of the present invention;

FIG. 8 is an enlarged sectional view illustrating a combined eyeglass frame according to fourth example of the present invention;

### DETAILED DESCRIPTION OF THE INVENTION

The present invention will be explained in detail with reference to the attached drawings.

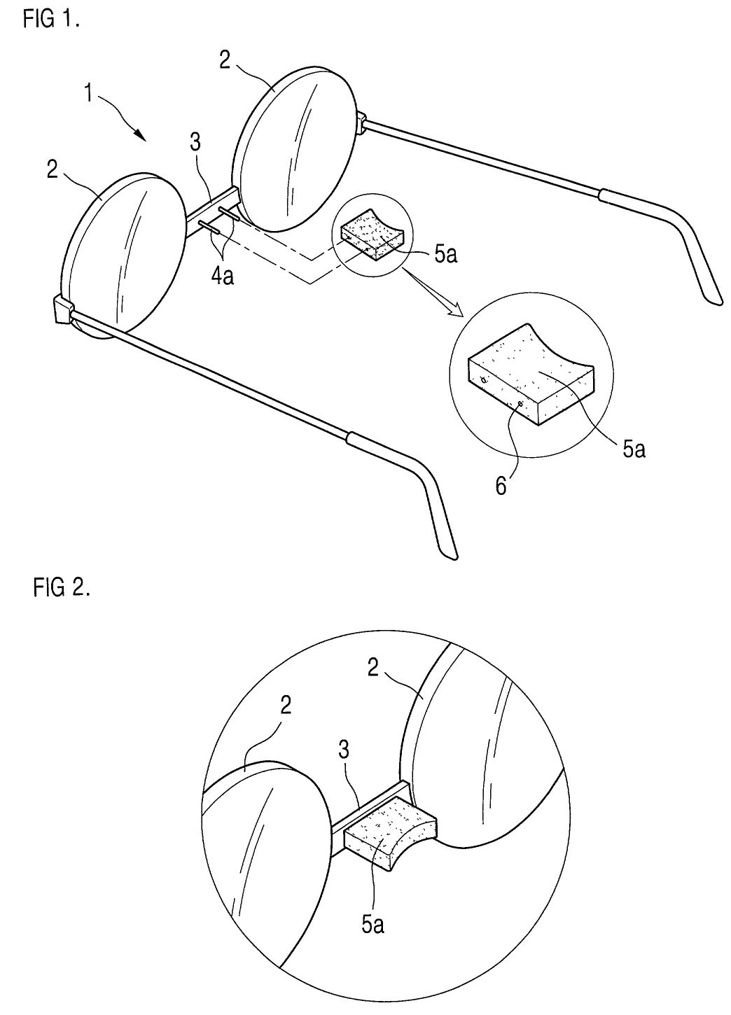

The first example of the present invention is illustrated in FIG. 1, 2. There are two protruding support members 4a on the inner side of the nose bridge 3. These two protruding support members are to be inserted and fixed into the two corresponding holes 6 which are apparent in the arc shaped pad 5a.

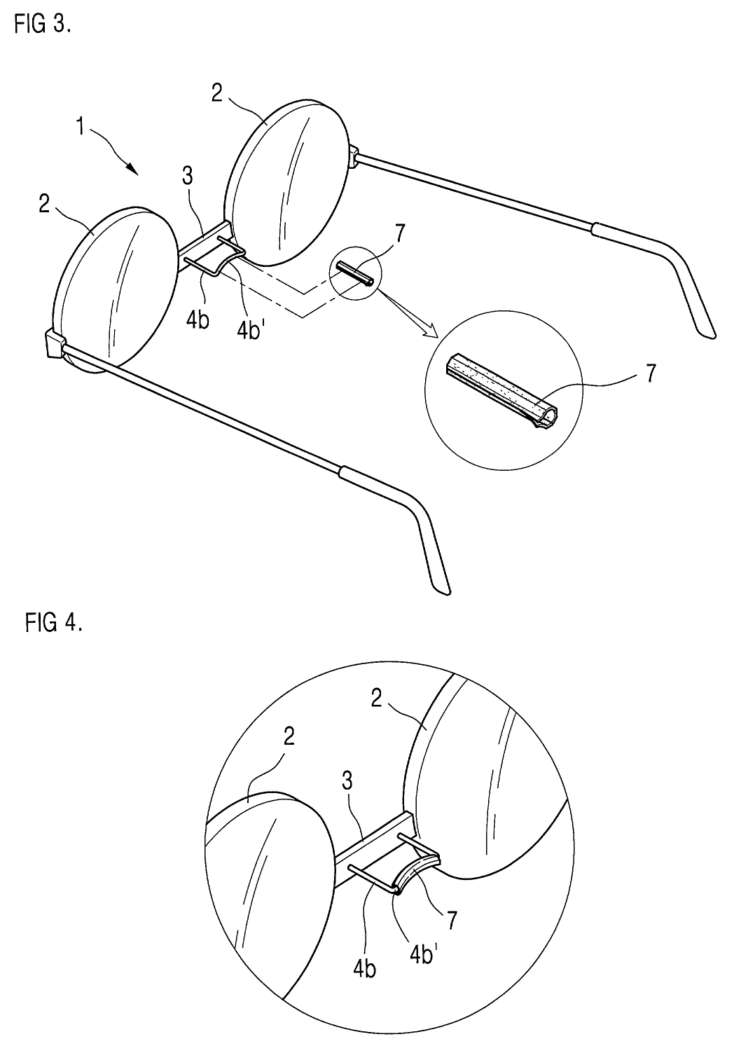

The second example of the present invention is illustrated in FIGS. 3, 4. There is an arc 4b′ joining the ends of the two supporting members 4b on the inner side of the nose bridge 3. Surrounding the arc joint is a soft multi-sided tube 7 which will provide a cushioning effect when placed against the nose.

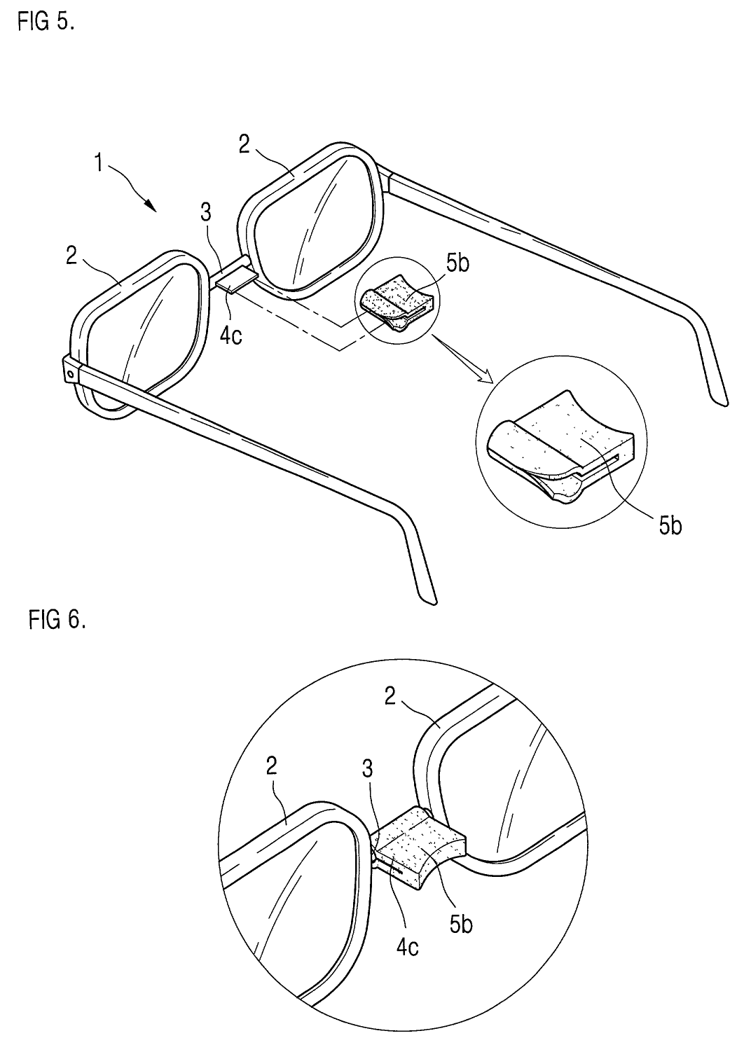

The third example of the present invention is illustrated in FIGS. 5, 6. There is a flat plate support 4c which protrudes from the inner side of the nose bridge 3. A soft arc shaped pad 5b covers over both the bridge 3 and the supporting member 4c while being fixed in place.

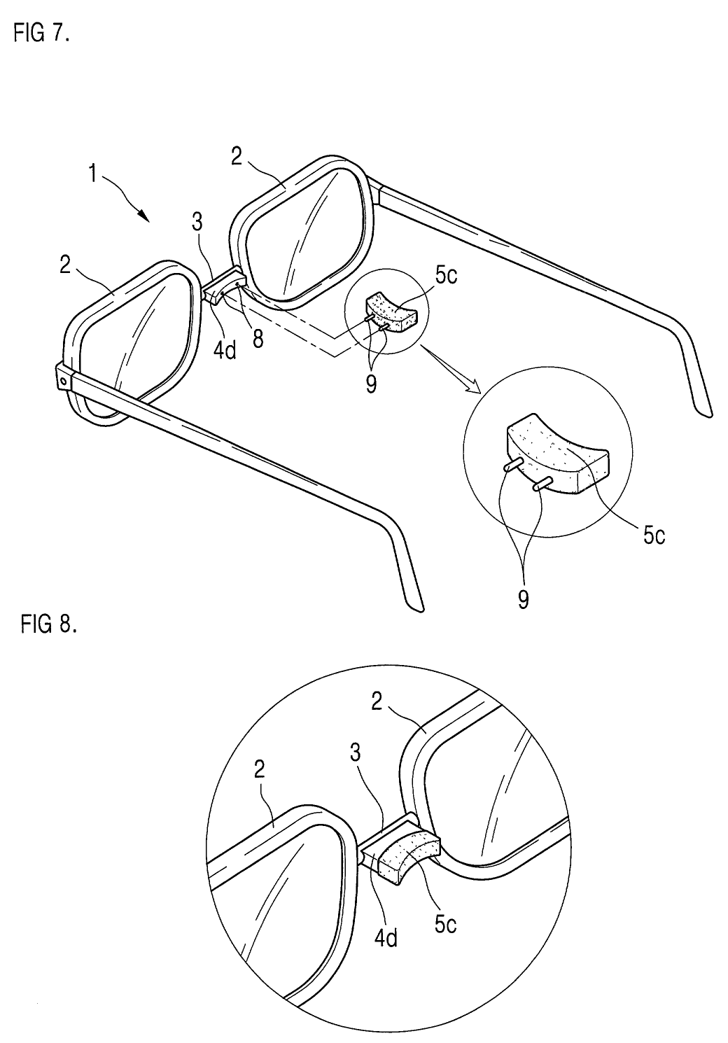

The fourth example of the present invention is illustrated in FIGS. 7, 8, On the inner side of the nose bridge 3 which is located half way up the frame, there is a protruding block support member 4d which has an arc cut out of it. On the end where the arc is cut out there are two holes 8 for two pins 9 to be inserted into. Using two pins the arc shaped pad 5c is pin joined to the supporting member.

All people who wear glasses have unique sizes and shapes to the nose. As the focus is on supporting the nose, the main shape is to have a nose bridge joining the two glass frames and to protrude a support member which will allow a pad to be fixed into place to minimize pressure on the nose. As is in the first example the arc shaped pad 5a is fixed onto the nose bridge 3 via the two protruding pins which are the supporting members 4a. In the second example, the two protruding support members 4b are joined by an arc 4b′ and this arc joint is covered with a soft multi-sided tube 7. In the third example, the protruding support member 4c is a flat plate. This support member and the nose bridge 3 is covered over with a soft arc shaped pad 5b. In the fourth example, there is a nose bridge 3 located exactly half way up the frames. From the inner side of the bridge protrudes a block support member 4d which has an arc shape cut out of it. On the end with the arc cut out are two holes 8 for pins to be located on. Using two pins 9 the arc shaped pad 5c is fixed onto the support member. These are the types of practical examples suggested to try to minimize the pressure on the ridge of the nose.

Effectiveness of the Invention

As described previously the eyeglass of this invention consists of a nose bridge connecting the two glass frames. From the inner side of the nose bridge there protrudes a support member which helps to hold in place a soft pad. This soft pad makes it effective in minimizing pressure on the nose and relieving the wearer of tiredness and stress which may come from wearing glasses. The simple shape and the use of minimal material results in the product having a low manufacturing cost. Being easy to manufacture will lower the probability of a defective product being produced.

What is claimed is:

1. An eyeglass in which lens pieces are connected by a nose bridge, having two support members protruding on the inner side of the nose bridge allowing for an arc shaped pad to be fixed onto the nose bridge and provide support at the nose.

2. An eyeglass according to claim 1, wherein the support member is of a pin shape allowing for the arc shaped pad to be fixed onto it via the hole which is located on the pad.

3. An eyeglass according to claim 1, wherein the two support members are joined at the tips via an arc joint allows for a soft multi-sided pad to cover this arc joint.

4. An eyeglass according to claim 1, wherein a flat plate support member allows for an arc shaped pad to be fixed in place while covering both the nose bridge and the support member at the same time.

5. An eyeglass according to one claim of claim 1, 2, wherein a block support member located half way up the glass frame has at one end an arc cut out of it and at that same end there are two holes for two pins to be located in allowing for the arc shaped pad to be fixed onto the support member.
